(19) United States
(12) Patent Application Publication
(10) Pub. No.: US 2008/0320600 A1
(43) Pub. Date: Dec. 25, 2008

(54) SECURE DOCUMENT MANAGEMENT SYSTEM AND APPARATUS

(76) Inventors: Matthew Pandiscia, Waterbury, CT (US); Susan Pandiscia, Waterbury, CT (US); Kurt Lange, Southington, CT (US)

Correspondence Address: MCCORMICK, PAULDING & HUBER LLP, CITY PLACE II, 185 ASYLUM STREET, HARTFORD, CT, 06103, US

(21) Appl. No.: 11/766,183

(22) Filed: Jun. 21, 2007

(51) Int. Cl. H04L 9/32; H04L 9/00

(52) U.S. Cl. 726/27

(57) ABSTRACT

A system for authenticating digital files includes an electronic device having means for handling digital files. The electronic device has a unique, hard encoded, device identifier. The system further includes a security key for interacting with the electronic device, the security key having a unique, hard encoded, key identifier. The electronic device further includes means for verifying a predetermined key-to-device association of the key identifier to the device identifier, means for refusing access to the electronic device upon unsuccessful key-to-device association verification, and means for associating both the device identifier and the key identifier with at least one of the handled digital files.

### FIELD OF THE INVENTION

This invention relates to a system and apparatus for controlling and tracking access to digital files. More specifically, this invention relates to a secure portable digital file manipulator.

### BACKGROUND AND SUMMARY OF THE INVENTION

People are increasingly using digital files to conduct business and transmit information. Privacy concerns give rise to a need for limiting access to the digital files to only those persons authorized for access. Further, security concerns and authenticity concerns give rise to a need for verifying and tracking access to the digital files.

Working in the office at a desktop computer is becoming a thing of the past. Portable electronic devices, including, for example, laptops and even handheld devices, are extremely convenient, allowing persons to access, edit, store, transmit and transport digital files from any location. Of course, the trade-off for portability, convenience and ease of use is that security considerations come into play. To be practically effective in many electronic commerce applications, portable electronic device designs should be tamper-resistant and secure.

This is particularly of concern as more and more sensitive legal, financial, contractual and other documents in the form of digital files are used to conduct official business, such as e-filing legal documents with a court or other governmental offices, or transacting financial matters, such as obtaining mortgages or conducting electronic trading etc. For these sensitive matters, it is imperative that the veracity or authenticity of the digital files, from creation through receipt by the relevant official, be verifiable.

Thus, what is needed is a secure portable electronic device that unambiguously denies access to the device and to digital files stored in the device to those persons not authorized to have access. Further, given the portability of the electronic device, there exists a need for a rights management system that incorporates a foolproof and tamper-resistant user/platform verification system. Even further, there is a need for a digital file management system that further verifies the authenticity and records the event/user history of digital files as they are accessed, stored or transmitted.

### SUMMARY OF THE INVENTION

In a first embodiment a system for authenticating digital files includes an electronic device having means for handling digital files. The electronic device has a unique, hard encoded, device identifier. A security key for interacting with the electronic device is provided, wherein the security key has a unique, hard encoded, key identifier. The electronic device further includes means for verifying a predetermined key-to-device association of the key identifier to the device identifier, means for refusing access to the electronic device upon unsuccessful key-to-device association verification, and means for associating both the device identifier and the key identifier with at least one of the handled digital files.

The system may further include at least one biometric sensing device to sense a biometric identifier, means for verifying a predetermined biometric-to-device association of the sensed biometric identifier to the device identifier, means for refusing access to the electronic device upon unsuccessful biometric-to-device association verification, means for verifying a predetermined biometric-to-key association of the sensed biometric identifier to the key identifier, and means for refusing access to the electronic device upon unsuccessful biometric-to-key association verification.

In one aspect, the electronic device may further include means for handling a digital file and means for associating a date-and-time identifier for a handling event with the digital file.

In another aspect, the electronic device may include means for accessing a digital file, means for storing the digital file, and means for associating an accessing date-and-time identifier and a storing date-and-time identifier with the digital file.

The system may further include means for downloading the digital file from a digital file storage system remote from the electronic device, wherein the electronic devices and the remote digital file storage system form a closed network.

The system may even further include means for downloading the digital file from a digital file storage system remote from the electronic device, and means for transmitting the device identifier to the remote digital file storage system.

In one aspect, the remote digital file storage system may utilize remote storage system file management software to verify that the transmitted device identifier is the same as the device identifier associated with the digital file.

The means for associating the device identifier and the key identifier with the digital file may include means for creating an encrypted metadata tag. Further, the means for associating the device identifier and the biometric identifier with the digital file may include means for creating an encrypted metadata tag.

In a further aspect of the embodiment, the electronic device may include means for entering a signature, means for verifying the signature, and means for associating the signature with the digital file.

Another embodiment a system for authenticating electronic documents includes a portable electronic device having an electronic document viewing and editing capability. The portable electronic device has a hard-coded device identifier. The system includes an electronic security key having a key identifier. The portable electronic device further includes a key reader system adapted to obtain the key identifier and document management software to associate the device identifier and the key identifier with an electronic document.

The system may further include key verification software to verify the compatibility of the key identifier to the device identifier and device access software to allow electronic input to the portable electronic device only upon successful verification of the key-to-device compatibility.

The system may even further include at least one biometric sensor to sense a biometric identifier and biometric verification software to verify the compatibility of the sensed biometric identifier to the device identifier. The device access software may further allow electronic input to the portable electronic device only upon successful verification of the biometric-to-device compatibility.

The system may also include at least one biometric sensor to sense a biometric identifier and biometric verification software to verify the compatibility of the sensed biometric identifier to the key identifier. The device access software may further allow electronic input to the portable electronic device only upon successful verification of the biometric-to-key compatibility.

In one aspect, the portable electronic device may further include accessing software to access the electronic document and storing software to store the electronic document. The document management software may further associate a document accessing date-and-time identifier and a document storing date-and-time identifier with the electronic document.

The system may include software to request download of the electronic document from a document storage system remote from the portable electronic device and software to transmit the device identifier to the remote document storage system.

In another aspect, the portable electronic device may include a device for entering a signature and verification software to verify the signature. The document management software may associate the signature with the electronic document.

The document management software may be configured to create an encrypted metadata tag associating the device identifier and the key identifier with the electronic document.

In another embodiment, a method for verifying the authenticity of an electronic document edited on a portable electronic device is provided. The portable electronic device has a unique hard-coded device identifier and a key reader. The method includes obtaining a key identifier from a key associated with an individual user, verifying a predetermined association between the key identifier and the device identifier and creating a key-to-device verification code, and allowing the individual user to operate the portable electronic device. The method further includes accessing the electronic document on the portable electronic device and creating an access date-time stamp, storing the electronic document and creating a store date-time stamp, and creating a metadata tag including information related to the device identifier, the key identifier, the access date-time stamp and the store date-time stamp. The metadata tag is associated with the electronic document.

The method may include transmitting the electronic document with associated metadata tag to a remote document management system.

The method may further include transmitting the device identifier and the key identifier to a remote document management system and requesting transmittal of an electronic document having a metadata tag associated therewith from the remote document management system to the portable electronic device.

Even further, the method may include obtaining a biometric identifier associated with a biometric characteristic of the individual user and including information related to the biometric identifier in the metadata tag.

### BRIEF DESCRIPTION OF THE DRAWINGS

These and other features and advantages of example embodiments in accordance with the invention may be better and more completely understood by referring to the following detailed description along with the drawings, of which:

FIG. 1 is schematic illustration of an exemplary embodiment of the electronic device of the present invention.

FIG. 2 is a flow chart illustrating an exemplary embodiment of the present invention of a procedure for gaining access to an operable electronic device.

FIGS. 3A and 3B are flow charts illustrating alternative exemplary embodiments of the present invention for gaining access to digital files stored in the electronic device.

FIG. 4 is a flow chart illustrating an exemplary embodiment of the present invention for gaining access for performing specific handling events to a digital file stored in the electronic device.

FIG. 5 is a flow chart illustrating an exemplary embodiment of the present invention for accessing and performing one or more handling events to a digital file template stored in a remote file storage database.

### DETAILED DESCRIPTION OF EXAMPLE EMBODIMENTS

A secure electronic device for handling digital files is described herein. A digital file may include, by way of non-limiting examples, word processing documents, graphic files, spreadsheets, computer programs, data files, etc. in any of a variety of formats. Digital file handling could include, by way of non-limiting examples, creating a file, downloading the file from memory (with or without opening the file), accessing the file, copying the file, viewing the file, editing or otherwise modifying the content of the file, printing the file, saving the file, closing the file, storing the file to memory and transmitting the file.

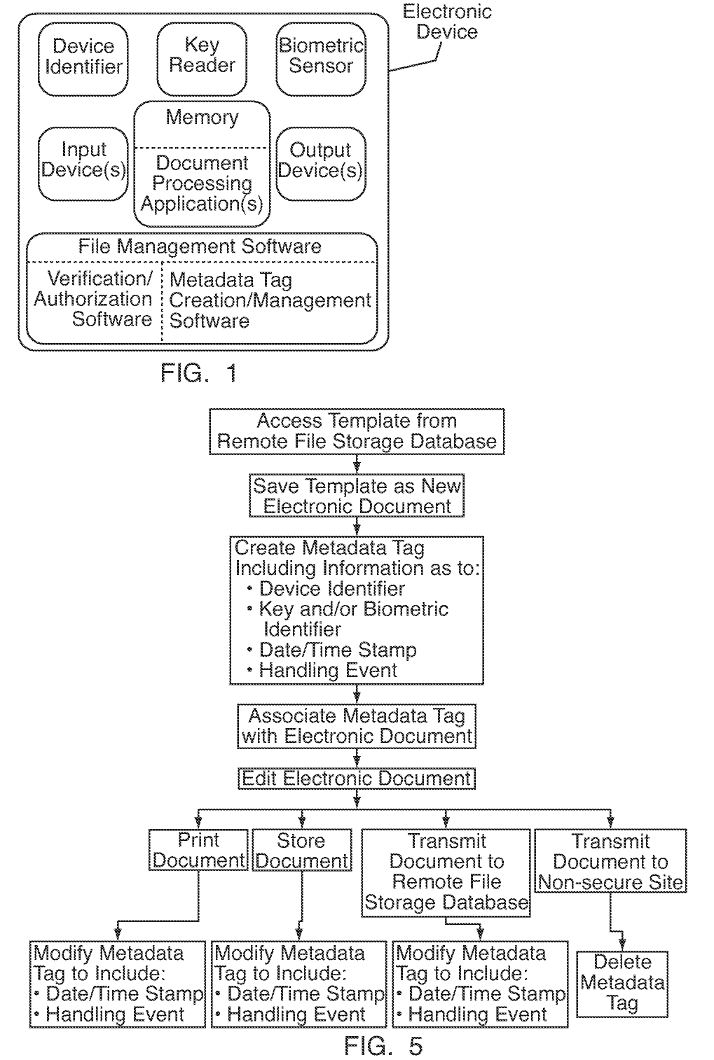

The electronic device could be portable, such that it travels with the user. Referring to FIG. 1, the electronic device could include input means for handling the digital files. These input means could include input devices such as, by way of non-limiting examples, one or more of a keyboard, a touch pad, an electronic pen, a mouse, a disk drive or other device for reading files from any of various file storage media, a microphone, a built-in scanner, USB or other ports, wireless access hardware, etc. The input means further could include any electronic circuitry and/or software programming supporting the operability of the input devices. The electronic device further could include output means for handling the digital files. These output means could include output devices such as, by way of non-limiting examples, one or more of a view screen, a disk drive or other device for writing files to any of various file storage media, a speaker, a built-in printer, USB or other ports, wireless transmitting hardware, etc. The output means further could include any electronic circuitry and/or software programming supporting the operability of the output devices.

Further, referring to FIG. 1, the electronic device further could include random access memory and/or temporary memory. The random access memory allows real-time manipulation of the digital files. The electronic device could further include built-in long-term memory storage, such that the digital files may be stored within the electronic device for later access and/or manipulation. Alternatively, the electronic device could be devoid of any long-term memory storage. In such case, the device could include input/output drives and/or ports and/or wireless capability so that manipulated digital files may be stored externally from the electronic device.

The electronic device further could include security means. The security means could include both electronic device access security means and digital file handling security means. The device access security means would be for limiting access to the electronic device in an operative state to only those users who are authorized for device access and/or for denying access to the electronic device in its operative state to users who are not authorized. The digital file handling security means would be for limiting handling of any particular digital file to only those users who are authorized for handling the digital file and/or for denying handling of any particular digital file to users who are not authorized.

The electronic device access security means could include a security access device. The security access device could include, by way of non-limiting examples, one or more of a multi-part physical lock, a software lock, a biometric access device, etc. The physical lock could include a key/key reader (see FIG. 1) such as, by way of non-limiting examples, a key/tumbler lock, a magnetic pass card key/scanner, a bar-code key/laser scanner or even a proximally-limited-range wireless key. The use of the term “physical lock” refers to a physical key that is separable from the key reader. The software lock could include, by way of non-limiting example, a password. A biometric access device could include a signature scanner, a fingerprint scanner, a retina scanner, a voice identifier, DNA scanner or other unique biometric identifying device (see FIG. 1). The electronic device access security means further could include any electronic circuitry and/or software programming supporting the operability of the security access devices.

The digital file handling security means could include file management software (see FIG. 1) for generating metadata tags for the digital files handled in the electronic device, for attaching the metadata tags to the digital files, and for verifying user access authorization to any specific digital file. The file management software could incorporate encryption protocols.

The electronic device could include a unique serial number that is hard encoded. For example, the electronic device could include one or more microprocessor chips, each having a unique hard-encoded serial number. One of these microprocessor chip's serial numbers could be assigned to the electronic device as its unique serial number. Thus, each and every electronic device would be uniquely identifiable for every other electronic device. Referring to FIG. 1, this unique serial number may be referred to as the electronic device identifier or the device identification number.

In one aspect of the invention, the electronic device would only be operative if the parts of a physical lock are joined or mated. Thus, for example, a two-part physical lock could include a key and a cylindrical lock. The electronic device would only be operative if the key fit the lock and if the key remains mated with the lock. Removing the key from the cylindrical lock would cause the electronic device to become inoperative. In one variation of this aspect, the key could be formed from two mating parts, such that the physical lock is comprised of three components. For a magnetic pass card key/scanner type lock, the electronic circuitry supporting the operability of this lock could be programmed to periodically confirm that the magnetic pass card key remains inserted or mated with the scanner. Similarly with the bar-code key/laser scanner and proximally-limited-range wireless scanner.

Referring to FIG. 2, this physical lock aspect of the invention could allow a prudent user of the electronic device to guarantee that the electron device is only operable when the user/custodian of the key is present. For example, a prudent user could physically attach the key, via chain or lanyard, to the body of the user, such that if the user is not in physical proximity to the electronic device, neither is the key and, accordingly, the electronic device is inoperable.

In other aspect of the invention, the key could be provided with a unique key identifier. Upon mating or interacting with the lock, such that the electronic device becomes operable, the key identifier could be read and stored in the memory of the electronic device. Security access software installed in the electronic device could be programmed to compare the key identifier to the device identifier (see FIG. 2) and to only allow the electronic device to operate upon verification that the key-to-device identifiers correspond to a pre-programmed, predetermined key-to-device association. In another aspect, more than one key may be paired with an electronic device, thus allowing more than one user to operate the device. In such case, the security access software installed in the electronic device could be programmed to compare the key identifier to the device identifier and to only allow the electronic device to operate upon verification that the key-to-device identifiers correspond to one of the authorized, pre-programmed, predetermined key-to-device association.

As also shown in FIG. 2, in another aspect of the invention, a biometric characteristic of the user could be sensed and compared to an authorized, pre-programmed or predetermined biometric characteristic stored in the electronic device. Upon comparison and verification that the sensed biometric characteristic of the user is the same as the authorized biometric characteristic, the electronic device would become operable. The biometric access device could include a biometric sensor that periodically senses and compares the user's biometric characteristic with the authorized biometric characteristic. For example, a biometric sensor could be incorporated into a key of a keyboard or into an electronic pen, such that a user's finger resting on a keyboard or holding an electronic pen could be periodically sensed. The biometric characteristic of each authorized user could be associated with a unique biometric identifier. Thus, in one aspect, the biometric access device could sense a user's biometric characteristic, compare it to the authorized user's biometric identifiers and store the verified biometric identifier in the memory of the electronic device.

In one aspect, the biometric identifier could be used to permit the electronic device to become operable. Further, one or more individuals could be authorized to operate an electronic device by programming the security access software to compare and verify that the sensed biometric characteristic matches one of the authorized, pre-programmed biometric identifiers. Even further, the security access software could compare and verify that the sensed biometric identifier corresponds to an authorized, pre-programmed, predetermined biometric-to-device association of the biometric identifier with the device identifier. A feature of the present invention could be for the security access software to compare and verify that the sensed biometric identifier corresponds to an authorized, pre-programmed, predetermined biometric-to-key association of the biometric identifier with an associated key identifier.

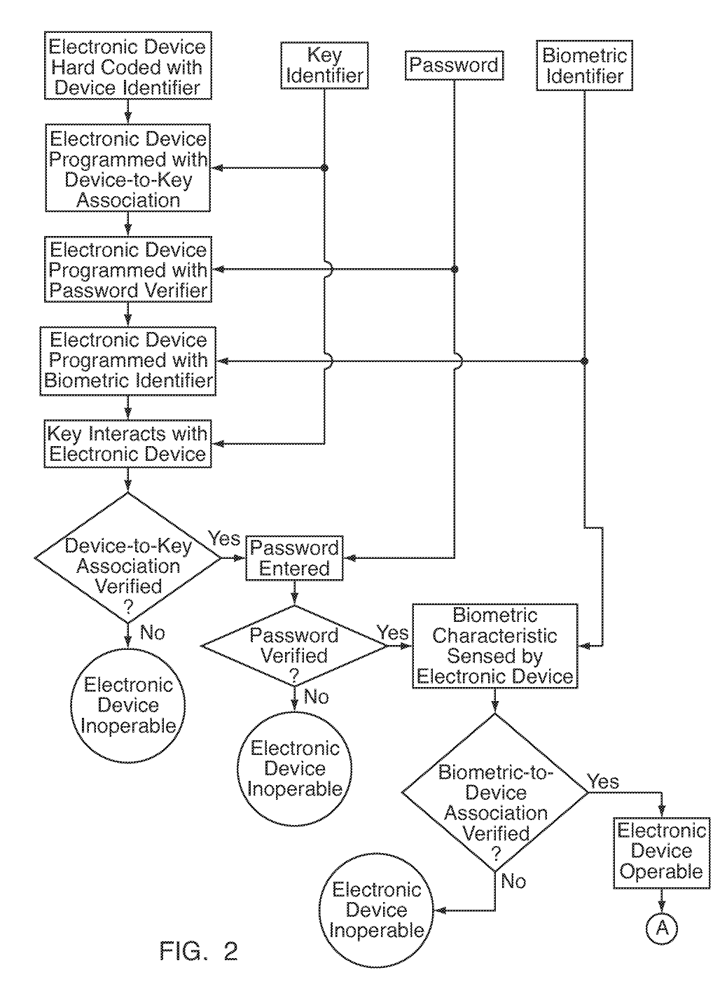

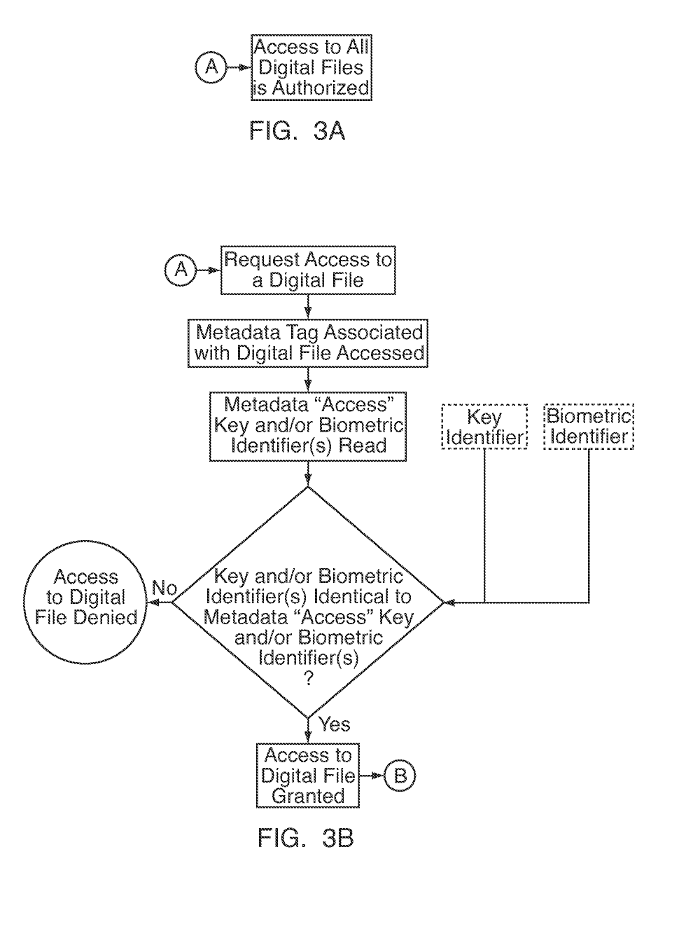

In one aspect of the invention, as best shown in FIG. 3A, gaining access to an operable electronic device would further provide authorized access to all digital files stored in the electronic device.

Alternatively, as presented in FIG. 3B, in another aspect, the biometric identifier could be used in conjunction with the digital file handling security means for limiting handling of any particular digital file to only those users who are authorized for handling that particular digital file and/or for denying handling of any particular digital file to users who are not so authorized. According to this aspect, the biometric identifier could be used to permit a user to handle a digital file. Further, one or more individuals could be authorized to handle any particular digital file by programming the digital file handling access software to compare and verify that the sensed biometric characteristic matches one of the authorized, pre-programmed biometric identifiers for that particular digital file.

The file management software associated with the digital file handling security means could include means for associating any of the above-discussed identifiers with a digital file. Thus, by way of non-limiting example, when a file is created, a metadata tag could be associated with the file and this metadata tag could include the device identifier associated with the electronic device used to create the digital file. Further, the metadata tag could optionally include the key identifier used to operate the electronic device and/or the biometric identifier of the user who created the digital file. The metadata tag could also include the day and time of the creation of the digital file. Additionally, if the user creating the digital file so wished, other key identifiers and/or biometric identifiers could be included in the metadata tag such that other users would be granted access to the digital file.

The file management software could be designed to associate a new or modified metadata tag to the digital file upon each handling event or upon a selected subset of handling events. Each modification of the metadata tag could include information as to the date, the time and the handling event. Further, each modification of the metadata tag could be appended or added to the information already associated with the existing metadata tag. Thus, a complete record of, for example, specified handling events, dates, times, device identifier and/or biometric identifier could be created. In this manner, the authenticity of the digital file could be verified. Thus, by way of non-limiting example, the metadata tag could be initially created upon the creation of the digital file and could be modified upon the storing of the digital file. By way of another non-limiting example, the metadata tag could be further modified upon downloading the digital file from storage, upon editing the file and/or upon printing the file.

Referring to FIG. 5, the electronic device could further include means for downloading a digital file and its associated metadata tag to or from a digital file storage system that is remote from the electronic device. The means for downloading could include, by way of non-limiting examples, internet and/or wireless communication between the electronic device and the remote storage system.

In one aspect of the present invention, upon receiving a request from an electronic device to download a digital file from the remote storage system to the electronic device, remote storage file management software would verify that one or more of the electronic device identifier, key identifier and/or biometric identifier are identified in the metadata tag as being associated with the requested digital file and as being authorized for handling of the digital file. The relevant identifiers may be provided with the initial request or the remote storage file management software may query the requesting electronic device for this information.

Upon verification that authorization is proper, the remote storage file management software would download the digital file (and its associated metadata tag) to the electronic device. Further, the metadata tag could be updated with the information associated with this handling event, i.e. the downloading from the remote storage system to the electronic device.

In another embodiment of the present invention, a method for verifying the authenticity of an electronic document edited on a portable electronic device is provided. As described above, the portable electronic device would have a unique hard-coded device identifier and a security access device, such as a key reader. The method could include obtaining key identifier information from a key associated with an individual user and verifying a predetermined association, i.e. the pre-programmed authorization, between the key identifier and the device identifier. Upon successfully verifying that the key identifier is an authorized match with the device identifier, the individual user would be allowed to operate the electronic device. As used herein, the term “electronic document” is broadly construed to mean a digital file.

In one aspect, the user would further be required to successfully enter a password in order to further operate the electronic device. In a further aspect, the user would also be required to provide a biometric characteristic for sensing by a biometric sensing device and upon successful verification that the sensed biometric identifier is an authorized match with the device identifier, the user would be allowed to operate the electronic device.

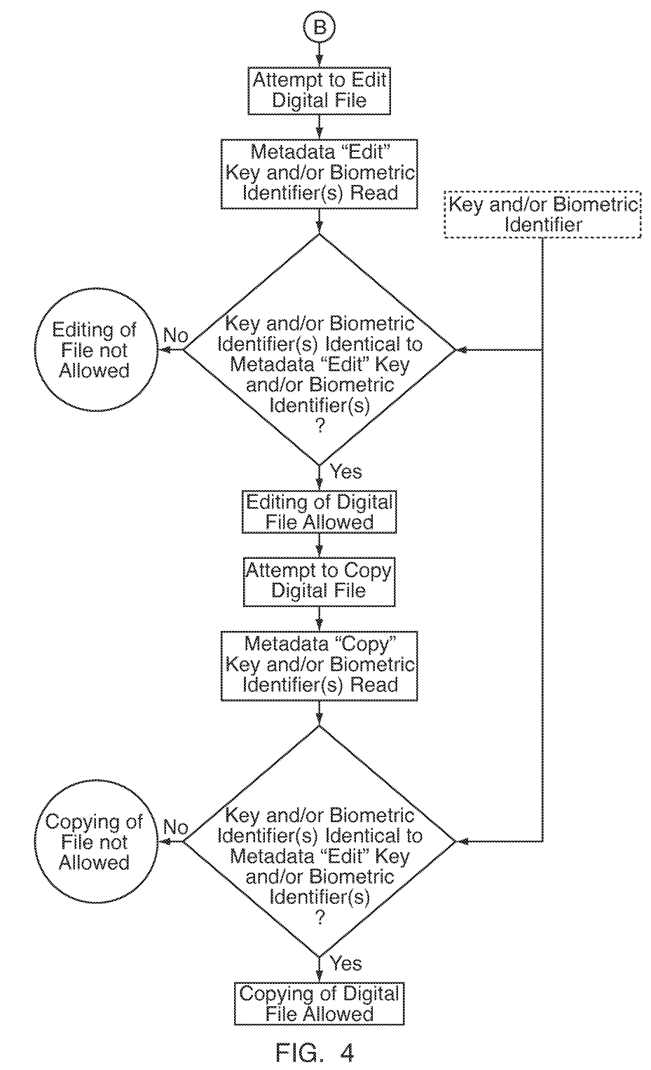

In another aspect, upon successfully gaining access to an operating electronic device, the user would be able to handle (i.e. access, view, edit, print, etc.) all electronic documents stored on the electronic device (see FIG. 3A). However, in a preferred aspect of the invention, the ability to handle any given electronic document would be premised upon at least one of the user's key identifier or biometric identifier being associated with an authorized key identifier or biometric identifier stored in the metadata tag associated with that given document (see FIG. 3B). Even further, the ability to conduct specific handling events would be premised upon at least one of the user's key identifier or biometric identifier being associated with an authorized key identifier or biometric identifier stored in the metadata tag associated with that given document (see FIG. 4). For example, upon successfully gaining access to an operating electronic device, by for example, having the user's key identifier matched with the authorized device identifier and by entering a password, the user would be allowed to view all electronic documents stored in the electronic device. However, to edit, print and/or copy, for example, a specific electronic document, the user's biometric identifier would need to match the authorized biometric identifier residing in that document's associated metadata tag. Other examples of limiting the ability to conduct specific handling events for specific documents are within the scope of the present invention.

The method could include creating a date and/or time stamp for inclusion in the metadata tag upon the occurrence of a handling event. The file management software could be configured such that all handling events are provided with a date-time stamp, or that only certain predetermined handling events are date-time stamped. For example, viewing the electronic document could trigger a date-time stamp and a handling event code be appended to the metadata tag. Alternatively, by way of non-limiting example, merely viewing the document may not trigger an update to the metadata tag, although making a copy or editing the document could trigger adding a date-time stamp and a handling event code to the metadata tag.

The method could further include transmitting the electronic document with its associated metadata tag to a remote document management system, and subsequently requesting transmittal of the document from the remote document management system back to the portable electronic device. In the course of requesting that the document be downloaded to the electronic device from the remote database, the file management software associated with the electronic device could transmit at least one of a device identifier, a key identifier and a biometric identifier to the remote database. The remote document management system could verify that the identifiers of interest for the specific document requested match those identifiers in the associated metadata tag.

In a preferred embodiment, only the inventive electronic devices would be associated with the remote document management system of the remote digital file storage system. In other words, the electronics devices and the remote digital file storage system would form a closed system. The remote file storage management system could be configured to only be compatible with the inventive electronic devices. In this aspect, i.e. the electronic devices/remote file storage system forming a closed network, the electronic devices themselves would not need authorization for communicating with the remote file storage management system because only the electronic devices are on the closed network and only the electronic devices would be compatible with the network.

In one example embodiment of an electronic device according to the invention, the electronic device could be used to maintain the integrity of electronic documents and to track the electronic document upon the occurrence of certain predetermined document handling events (i.e. when viewed, edited, etc.). The electronic device could have many uses, including creating viewing, signing, initialing, writing, editing, recording, and creating documents that are deemed uncompromised and final by governmental authorities, judicial authorities, legal and financial business receiving the documents.

The electronic device would have a unique serial number that is hard encoded that will identify the device. Further, this unique serial number could be used to limit access to the device to only those persons authorized to have access. Additionally, this unique serial number could be used to track document handling events, as discussed above, in order to verify or certify the authenticity of the documents.

The electronic device could be equipped for document storage as well as for handling all electronic paperwork, including legal, non-legal and contractual documents. This device could use an open interface that would be compatible with existing electronic communication technologies. The device could allow a user to securely transfer and receive any document over a secured connection, including networks, email, and direct connections, and the internet (SSL or VPN). The device could further allow for scanning of editable documents directly into the device using either a scanning device or other attached imaging device. Compatibility with computer systems could be provided. Preferably, the device could be portable and could have an interface that is user friendly, thereby making navigation easy. The device could include, but not be limited to, a portable keyboard device.

The device could utilize a touch screen system to provide for on screen text writing, manipulation, document composition and navigation of the device in its entirety, as well as signature recognition and recording. The touch screen could be a LCD screen. Such a screen uses a thinner more accurate pen then the traditional stylus, which has the same width as a traditional pen but with a thinner tip. This pen allows for more accurate input. The screen could be provided with signature recognition software that will allow for signature verification and accurate signature input. Thus, with this configuration, device could also include an electronic notary system that could allow for notary signatures to be added to the document along with appropriate identification that conforms to current notary standards. Voice recognition, as well as transcribing technology could additionally be provided.

The electronic device would preferably provide for an “open interface” with all known and upcoming open office software and office application systems for computers. This interface could be configured to be able to securely retrieve from internet (SSL) any data or existing forms. The device could further utilize a centralized document management authority. The device could also provide for document location stamping upon the occurrence of a predetermined handling event using GPS technology.

In one aspect, the electronic device could include, but is not limited to, USB and/or Bluetooth technology to connect the devices to peripherals such as printers, computers, scanners, cameras, memory sticks, a mouse, and/or a keyboard. Optionally, the device could include a keyboard having a direct connect port to the device, such that the electronic device and the keyboard could function as an integral unit. More than one peripheral port could be provided such that multiple peripheral devices could be connected at the same time.

The electronic device would be configured to run software to easily navigation through the device and its functions. Such software should allow for viewing, signing, initialing, writing, editing, and creating of all documents, including legal documents. A software program could be provided to recognize, verify, and protect all required signatures, initials, seals, etc. that are associated with the document in order to certify their authenticity. Software could be written to recognize and/or translate among several languages including English. This feature could allow for easily converting a legal documents certified in one country to be certified or deemed legal by authorities in another country.

In another aspect, the electronic device could be provided with software having a document creation program. This program would ideally contain thousands of templates for many kinds of commonly used documents. These templates could be essentially limitless in its number, with agencies creating and adding new templates as need be to the software via email, internet or other upload methods. Thus, software could be created to customize this device for any industry or company.

The electronic device could also include a system for storing documents on the device. The device could function as a filing mechanism for all types of documents including legal documents, bills, notes, statements, and others. The device could further include software for categorizing or organizing the documents in any of various ways (alphabetically, chronologically, document type etc.) in order to keep everything in order.

In its preferred embodiment, the electronic device could have up to three (3) security levels or tiers for entry (i.e. operability) into the device.

A first level of security could include a key that could be used to unlock the device and allow a user to operate the device. The key could be hard-coded with selected user information. By way of non-limiting examples, the key could include information related to the users name (ID code Key), clearance level, device identification number (DIN) or other specific verifying information. The device could be programmed with the same information. The key could act as a digital password such that only a specific key could unlock a specific electronic device. If information programmed into the electronic device does not match the information provided by the key, then the device could not power on (refuse access). The electronic device would be configured such that there is no manual override.

In one aspect, the key could be interactive. In other words, the key could be a mini data storage device, such as a USB device. Alternatively, the key could be similar to a smartcard. Further the key could be used to track the user from the time the user inserts the key until the time the user removes the key. In another aspect, the key could additionally be used to protect against the accidental separation of the user and the electronic device.

A second level of security could include password protection as is known by persons of ordinary skill in the art.

A third level of security could include biometric sensing devices. For example, the device could be equipped with fingerprinting technology in association with the assigned electronic key that must be accompanied when activating the device. Fingerprinting technology could also aid in situations where legal documents are involved and might require someone to verify their identity.

These three levels of security guarantee that only persons who are authorized to access the documents in the device actually are given access to the documents. This will be optional, as ordinary passwords will also be an option. The electronic device may use other biometric characteristics to verify the identity of the user, such as retina scanning, voice recognition or signature comparison.

As an added safety feature that prevents against misuse of a stolen or lost device, the device could have a disabling mechanism. The disabling mechanism could be either a hardware or a software disabling mechanism (to wipe clean or destroy the device's memory) and which could be triggered if the electronic device is stolen. Further, the electronic device could be provided with a system for automatically periodically (on by command) purging files and documents. This additional safety feature would insure that files and documents cannot be accessed once they are purged from the system—files that are meant to be erased would be removed from the electronic device without hope of recovery.

The electronic device could use a secure centralized authority that would hold uncompromised, original and traceable copies of documents. Such a secure centralized authority or centralized document hosting facility could be managed by a municipality, government agency, private business or other servicing company. In one optional aspect, once a document is placed into the centralized hosting facility it would no longer be edited. A private network could also be provided to securely allow only devices connected to the private network to view such documents. Further, optionally, the electronic device could be programmed to update with a central server that can keep real time information. This will allow for companies, organizations, individuals, and governments to have real time information in a world that requires its information to be up to date and accurate.

Metadata tags, as discussed above, could be used to verify and/or track the history of the documents. These documents would all be traceable by electronic information letting the network know, for example, who edited the document and when, along with any other information that the device intakes. Each document could have an associate code for tracking the document. Documents could require entry information in order to edit documents such as, a password, fingerprint identification and/or key entry.

The following description provides an exemplary embodiment of a method for using the electronic device to track, or provide a history for, the electronic documents handled by the electronic device.

One object of the invention is to create any kind of electronic document and providing this document with a verifiable history. For example, if a user were to create a document using the electronic device, the device could automatically apply or associate the device identifier, the key identifier, a biometric identifier and/or a global positioning satellite (GPS) information to the document in the form of a metadata or software tag. This metadata tag could be tamperproof, such that it could not be altered, either by the document's creator, a recipient of the document or a third party. If the document were to be printed, or otherwise sent outside the electronic device, the historical data would accompanies it as well. Moreover, if the document were to be transmitted from one device to another device, this information regarding this transmittal handling event could be appended to the existing metadata tag and passed on with the document. For example, if the destination electronic device were to acquire the document, the destination device's device identifier and/or key identifier and/or user's biometric identifier and/or GPS information could then be appended to the history of the document. Thus a record could be built of how many times the document has changed hands. If the document were to be altered by a user (whether using the source or destination electronic device) the modification date followed by the device identifier, key identifier, user's biometric identifier, etc. could be appended to the document's history.

In one embodiment, only the electronic devices would be allowed to modify the contents of any document. The electronic devices would not have the ability to alter the history of the document. The history and recording is strictly done by the file management system itself. Further, only the electronic devices would be able to view and verify a documents authenticity. In a further aspect, a document from handled by an electronic device, which is subsequently transmitted electronically outside electronic device/remote file storage system would have all the metadata handling history erased and replaced with a voided electronic signature. This would void the document as being authentic and the document would not be usable as an original document

Thus, the electronic devices/remote file storage system could provide a secure means for viewing, authenticating, tracking and historical viewing, and editing of a digital file. The electronic device could include an open user interface, including but not limited to, a touch screen interface or other type of graphical user interface(GUI). A metadata tag associated with the digital file could include, but not limited to, synchronized date and time stamp, gps coordinates, device identifier, key identifier, and biometric data. The metadata information would provide an ongoing record on digital file for historical viewing and authenticating the file.

A means for verifying a predetermined key-to-device association could include an administrative utility residing on the electronic device that is used the first time the electronic device is programmed for assignment to a particular user. This utility could associate that user's personal key information with this particular electronic device. Similarly, a means for verifying a predetermined biometric-to-device association could include an administrative utility residing on the electronic device that is also used the first time the electronic device is programmed for assignment to a particular user. This utility could associate that user's biometric information with this particular electronic device. In one less preferred aspect, more than one key or biometric characteristic may be associated with each electronic device.

A means for accessing and/or storing electronic documents from the electronic device to the remote document storage system; could be accomplished by any of the following including, but not limited to, public or private internet Ethernet, wireless and satellite links. Every electronic device could have the capability to send original, authenticated digital files to another electronic device via the electronic device/remote file storage system.

A means for inputting a signature could include, but is not limited to, the open user interface. A means of verifying the signature could be accomplished by placing a biometric identifier in the metadata tag along with the signature. Also, the authorized user and/or authorized representative, such as but not limited to a notary or attorney, could identify that person as the person signing and this information could also be included in the metadata tag.

A means for creating an encrypted and/or hidden metadata tag could include using known encryption programming.

The present invention is not meant to be limited to the above-disclosed specific exemplary embodiments, but is intended to encompass variations and equivalents as defined within the spirit and scope of the claims.

What is claimed is:

1. A system for authenticating digital files, comprising:
an electronic device having means for handling digital files, the electronic device having a unique, hard encoded, device identifier;
a security key for interacting with the electronic device, the security key having a unique, hard encoded, key identifier; and
the electronic device further including:
means for verifying a predetermined key-to-device association of the key identifier to the device identifier;
means for refusing access to the electronic device upon unsuccessful key-to-device association verification; and
means for associating both the device identifier and the key identifier with at least one of the handled digital files.

2. The system of claim 1, further comprising:
at least one biometric sensing device to sense a biometric identifier;
means for verifying a predetermined biometric-to-device association of the sensed biometric identifier to the device identifier;
means for refusing access to the electronic device upon unsuccessful biometric-to-device association verification;
means for verifying a predetermined biometric-to-key association of the sensed biometric identifier to the key identifier; and
means for refusing access to the electronic device upon unsuccessful biometric-to-key association verification.

3. The system of claim 1, wherein the electronic device further comprises:
means for handling a digital file; and
means for associating a date-and-time identifier for a handling event with the digital file.

4. The system of claim 1, wherein the electronic device further comprises:
means for accessing a digital file;
means for storing the digital file;
means for associating an accessing date-and-time identifier and a storing date-and-time identifier with the digital file.

5. The system of claim 4, wherein the means for accessing includes means for downloading the digital file from a digital file storage system remote from the electronic device, and wherein the electronic devices and the remote digital file storage system form a closed network.

6. The system of claim 4, wherein the means for accessing includes means for downloading the digital file from a digital file storage system remote from the electronic device, and wherein the means for accessing further includes means for transmitting the device identifier to the remote digital file storage system.

7. The system of claim 6, wherein the remote digital file storage system utilizes remote storage system file management software to verify that the transmitted device identifier is the same as the device identifier associated with the digital file.

8. The system of claim 1, wherein the means for associating the device identifier and the key identifier with the digital file includes means for creating an encrypted metadata tag.

9. The system of claim 2, wherein the means for associating the device identifier and the biometric identifier with the digital file includes means for creating an encrypted metadata tag.

10. The system of claim 1, wherein the electronic device further comprises:
means for entering a signature;
means for verifying the signature; and
means for associating the signature with the digital file.

11. A system for authenticating electronic documents, comprising:
a portable electronic device having an electronic document viewing and editing capability, the portable electronic device having a hard-coded device identifier;
an electronic security key having a key identifier;
wherein the portable electronic device further includes:
a key reader system adapted to obtain the key identifier; and
document management software to associate the device identifier and the key identifier with an electronic document.

12. The system of claim 11, further comprising:
key verification software to verify the compatibility of the key identifier to the device identifier; and
device access software to allow electronic input to the portable electronic device only upon successful verification of the key-to-device compatibility.

13. The system of claim 12, further comprising:
at least one biometric sensor to sense a biometric identifier;
biometric verification software to verify the compatibility of the sensed biometric identifier to the device identifier; and
wherein the device access software further allows electronic input to the portable electronic device only upon successful verification of the biometric-to-device compatibility.

14. The system of claim 12, further comprising:
at least one biometric sensor to sense a biometric identifier;
biometric verification software to verify the compatibility of the sensed biometric identifier to the key identifier; and
wherein the device access software further allows electronic input to the portable electronic device only upon successful verification of the biometric-to-key compatibility.

15. The system of claim 11, wherein the portable electronic device further comprises:
accessing software to access the electronic document;
storing software to store the electronic document; and
wherein the document management software further associates a document accessing date-and-time identifier and a document storing date-and-time identifier with the electronic document.

16. The system of claim 15, wherein:
the accessing software includes software to request download of the electronic document from a document storage system remote from the portable electronic device; and
the accessing software further including software to transmit the device identifier to the remote document storage system.

17. The system of claim 11, wherein the portable electronic device further comprises:
a device for entering a signature;
verification software to verify the signature; and
wherein the document management software associates the signature with the electronic document.

18. The system of claim 11, wherein the document management software is configured to create an encrypted metadata tag associating the device identifier and the key identifier with the electronic document.

19. A method for verifying the authenticity of an electronic document edited on a portable electronic device, the portable electronic device having a unique hard-coded device identifier and a key reader, comprising:
obtaining a key identifier from a key associated with an individual user;
verifying a predetermined association between the key identifier and the device identifier and creating a key-to-device verification code;
allowing the individual user to operate the portable electronic device;
accessing the electronic document on the portable electronic device and creating an access date-time stamp;
storing the electronic document and creating a store date-time stamp;
creating a metadata tag including information related to the device identifier, the key identifier, the access date-time stamp and the store date-time stamp; and
associating the metadata tag with the electronic document.

20. The method of claim 19, further comprising:
transmitting the electronic document with associated metadata tag to a remote document management system.

21. The method of claim 19, further comprising:
transmitting the device identifier and the key identifier to a remote document management system; and
requesting transmittal of an electronic document having a metadata tag associated therewith from the remote document management system to the portable electronic device.

22. The method of claim 19, further comprising:
obtaining a biometric identifier associated with a biometric characteristic of the individual user; and
including information related to the biometric identifier in the metadata tag.
